(19) United States
(12) Patent Application Publication
(10) Pub. No.: US 2016/0011495 A1
(43) Pub. Date: Jan. 14, 2016

(54) PROJECTION TYPE IMAGE DISPLAY DEVICE

(71) Applicant: Panasonic Intellectual Property Management Co., Ltd., Osaka (JP)

(72) Inventors: Atsushi TAKAGI, Osaka (JP); Shinya NODA, Osaka (JP)

(21) Appl. No.: 14/857,126

(22) Filed: Sep. 17, 2015

Related U.S. Application Data
(63) Continuation of application No. PCT/JP2014/002202, filed on Apr. 18, 2014.

(30) Foreign Application Priority Data
Apr. 18, 2013 (JP) 2013-087161
Jul. 4, 2013 (JP) 2013-140453
Nov. 5, 2013 (JP) 2013-229154
Nov. 5, 2013 (JP) 2013-229157
Nov. 5, 2013 (JP) 2013-229161

(51) Int. Cl. G03B 21/14; G03B 21/00

(52) U.S. Cl. CPC G03B 21/145; G03B 21/005

(57) ABSTRACT

The projection type image display device includes a first housing that houses a light source unit, an image generating unit and a projecting unit, a second housing, and a joint unit configured to connect the first housing and the second housing and support the first housing to be able to rotate within a predetermined angular range. The joint unit includes a ball joint mechanism having a shaft member with a spherical portion, a first holding portion embracing and holding the spherical portion, and a second holding portion. The spherical portion of the shaft member is held rotatably by the first holding portion. The first holding portion is configured to be rotatable around a predetermined rotational axis against the second holding portion.

### CROSS-REFERENCE TO RELATED APPLICATIONS

This is a continuation application of International Application No. PCT/JP2014/002202 with an international filing date of Apr. 18, 2014, which claims priority of Japanese Patent Application Nos.: 2013-087161 filed on Apr. 18, 2013; 2013-140453 filed on Jul. 4, 2013; 2013-229154 filed on Nov. 5, 2013; and 2013-229157 filed on Nov. 5, 2013, and 2013-229161 filed on Nov. 5, 2013, the contents of which are incorporated herein by reference.

### BACKGROUND

1. Technical Field

The present disclosure relates to a projection type image display device provided with a housing including a light source and with a support portion rotatably supporting the housing.

2. Related Art

Today a projector is widely prevalent as a projection type image display device that magnifies and projects various images, and so on, on a screen. The projector modulates light emitted from a light source according to a video signal, by means of a spatial light modulator such as a digital micromirror device (DMD) or a liquid-crystal display element, to project the modulated light on the screen.

Various projectors have also been developed that are disposed on a ceiling to project images on a floor or a wall surface. The projectors disposed for use on the ceiling entail various problems to be studied, such as necessity for dedicated holders or wiring works, storage method, device size reduction, easiness in work, ease of use, and aesthetic sense.

In view of these problems, for example, Japanese Laid-Open Patent Publication No. 2008-185757 proposes a projection type image display device having a connector which is attachable to a wiring fixture for illumination and having an illumination device disposed on a housing surface facing the floor.

For example, when the projector is disposed on the ceiling to project an image onto the floor surface or the wall surface, projection light of the projector is downwardly projected. At that time, there arises a need to adjust the angle of emergence of projection light from the projector so as to display an image at a predetermined position on the floor surface or the wall surface.

It is therefore desired for the projector to have a configuration capable of freely adjusting the posture (angle) of the body (see, e.g., Japanese Laid-Open Patent Publication Nos. 2004-336615 and 2009-204902).

### SUMMARY

The present disclosure provides a projection type image display device capable of arbitrarily adjusting the angle of emergence of projection light.

In one aspect, a projection type image display device is provided. The projection type image display device includes: a light source unit; an image generating unit configured to modulate light from the light source unit according to a video input signal to generate image light; a projecting unit configured to project the image light generated; a first housing that houses the light source unit, the image generating unit, and the projecting unit; a second housing; and a joint unit configured to connect the first housing and the second housing, and support the first housing to be able to rotate within a predetermined angular range. The joint unit includes a ball joint mechanism having a shaft member with a spherical portion, a first holding portion embracing and holding the spherical portion, and a second holding portion. The spherical portion of the shaft member is held rotatably by the first holding portion. The first holding portion is configured to be rotatable around a predetermined rotational axis against the second holding portion.

According to the present disclosure, there can be provided a projection type image display device capable of arbitrarily adjusting the angle of emergence of projection light.

### BRIEF DESCRIPTION OF DRAWINGS

FIG. 1 is a perspective view of a projection type image display device according to a first embodiment of the present disclosure.

FIG. 2 is a block diagram showing the configuration of the projection type image display device.

FIG. 3 is a view explaining the optical configuration of the projection type image display device.

FIG. 4 is a view explaining a second housing of the projection type image display device.

FIGS. 5A-5C are views for explaining the configuration of a joint unit.

FIG. 6 is a development view for explaining the configuration of the joint unit.

FIG. 7 is a view for explaining a notched portion and a support portion of the joint unit.

FIG. 8 is a view for explaining rotation (yawing) of a first housing against the second housing, around a vertically extending rotational axis.

FIG. 9 is a view for explaining rotation (rolling) of the first housing against the second housing, around a horizontally extending rotational axis.

FIG. 10 is a view for explaining rotation (pitching) of the first housing against the second housing, around the horizontally extending rotational axis.

FIGS. 11A and 11B are views explaining an example of a specific posture which the first housing can take against to the second housing.

FIGS. 12A and 12B are views explaining an example of the specific posture which the first housing can take against the second housing.

FIGS. 13A and 13B are views explaining an example of the specific posture which the first housing can take against the second housing.

FIG. 14 is a perspective view of the projection type image display device according to a second embodiment of the present disclosure.

FIG. 15A is a front view of the projection type image display device according to the second embodiment of the present disclosure, and FIG. 15B is a side view of the projection type image display device.

FIG. 16 is a perspective view of the projection type image display device according to a third embodiment of the present disclosure.

FIG. 17 is a front view of the projection type image display device according to the third embodiment of the present disclosure.

FIG. 18 is a view for explaining the configuration of the joint unit in the third embodiment.

### DETAILED DESCRIPTION OF THE EMBODIMENTS

Embodiments will hereinafter be described in detail with proper reference to the drawings. Note however that excessively detailed description may be omitted. For example, detailed description of already well-known matters and repeated description of substantially the same configuration may be omitted. This is for the purpose of preventing the following description from becoming unnecessarily redundant, to facilitate the understanding of those skilled in the art.

The inventors provide the accompanying drawings and the following description in order for those skilled in the art to fully understand the present disclosure and it is not intended to limit the subject matters defined in the claims by them.

### First Embodiment

### 1. Overall Configuration of Projection Type Image Display Device

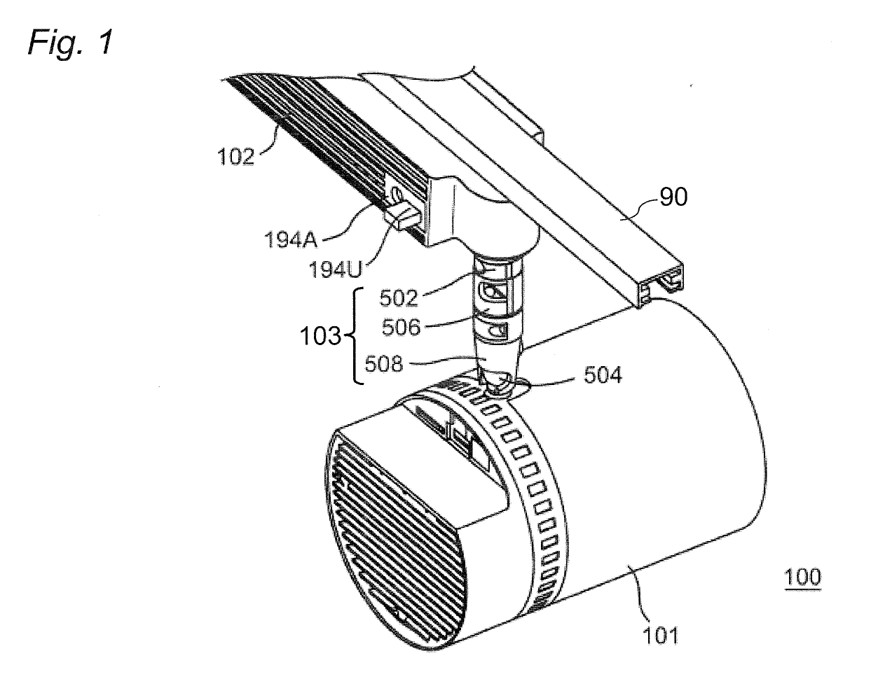

A projection type image display device will now be described with reference to the drawings. FIG. 1 is an external perspective view of a projection type image display device 100. As shown in FIG. 1, the projection type image display device 100 has a first housing 101 that mainly houses optical members in its interior and a second housing 102 that mainly stores a power-supply board in its interior. The first housing 100 has a cylindrical shape. The first housing 101 and the second housing 102 are connected together via a joint unit 103. The joint unit 103 is provided with a ball joint mechanism to rotatably support the first housing 101. The details of the joint unit 103 will be described later.

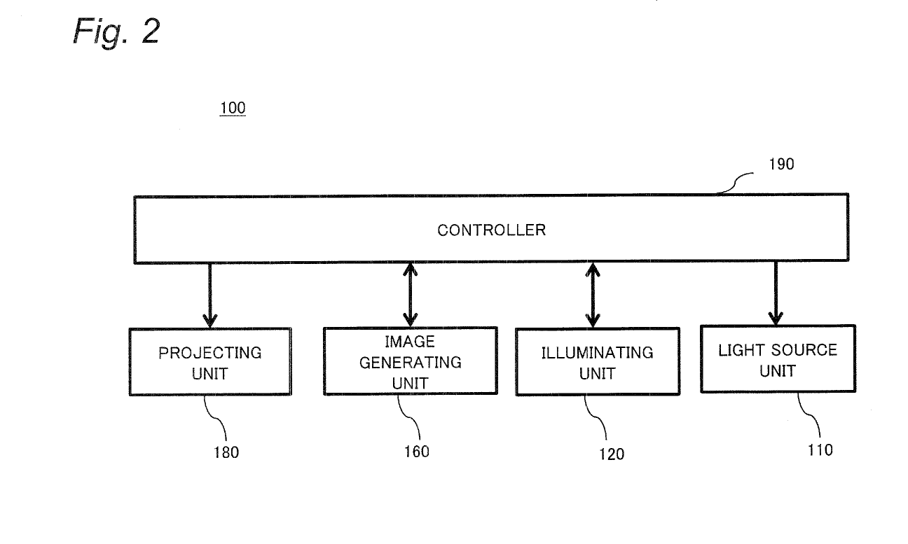

FIG. 2 is a block diagram showing the functional configuration of the projection type image display device 100. As shown in FIG. 2, the projection type image display device 100 has a light source unit 110, an image generating unit 160 that generates image light according to a video input signal, an illuminating unit 120 that guides the light from the light source unit 110 to the image generating unit 160, a projecting unit 180 that projects image light generated by the image generating unit 160 onto a screen (not shown), and a controller 190 that controls the light source unit 110, the illuminating unit 120, the image generating unit 160, and so on.

The light source unit 110 of the present disclosure has a semiconductor laser which emits light, as excitation light, to excite fluorescent substance to emit light. The illuminating unit 120 is configured from optical members such as various lenses, mirrors, or rods to guide light emitted from the light source unit 110 to illuminate the image generating unit 160. The image generating unit 160 uses elements such as a digital micromirror device (hereinafter, referred to as “DMD”) and a liquid-crystal panel to spatially modulate light according to a video signal. The projecting unit 180 is configured from optical members such as lenses and mirrors to magnify and project the spatially modulated light.

### 2. Internal Configuration of First Housing

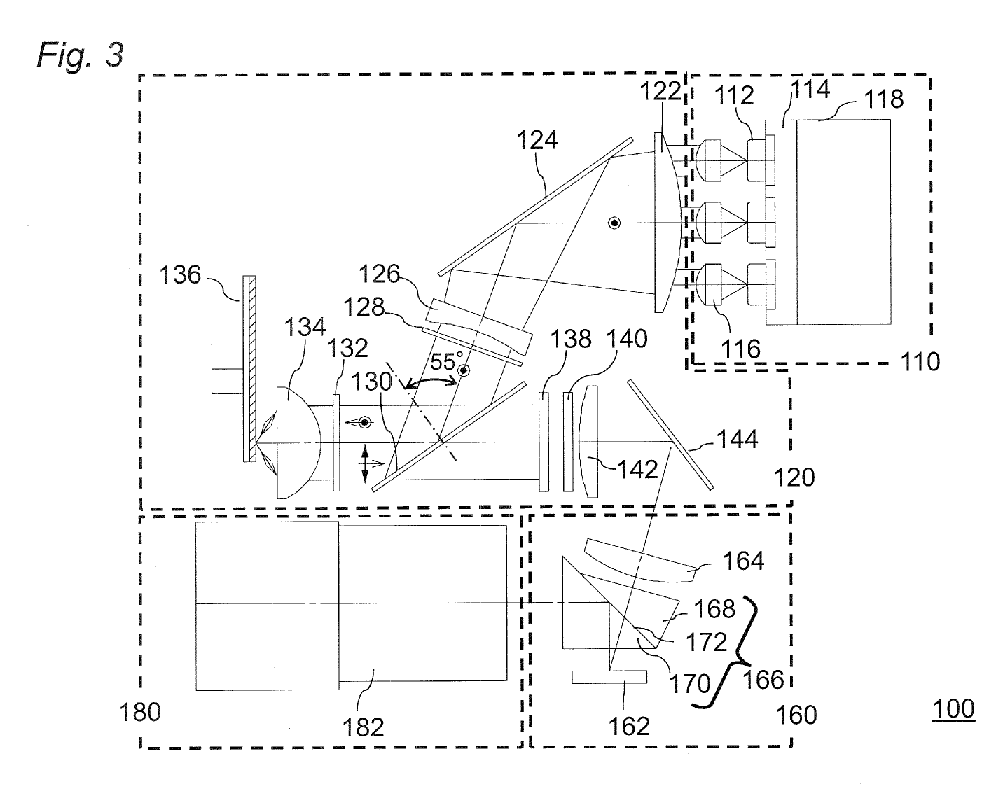

The internal configuration of the first housing 101 of the projection type image display device according to the present disclosure will be described with reference to FIG. 3. FIG. 3 is a view explaining the optical configuration of the projection type image display device 100, housed in the first housing 101.

As shown in FIG. 3, the projection type image display device 100 is configured from the light source unit 110, the image generating unit 160 that generates image light according to a video input signal, the illuminating unit 120 that guides light from the light source unit 110 to the image generating unit 160, and the projecting unit 180 that projects the image light generated by the image generating unit 160 onto a screen (not shown).

The light source unit 110 includes twelve semiconductor laser elements 112 arranged on a radiator plate 114 at certain intervals and two dimensionally in three rows and four columns, with each of lenses 116 facing each of the semiconductor laser elements 112. The lenses 116 condense light emitted from the corresponding semiconductor laser elements 112 into parallel light.

A heat sink 118 is disposed at the back of the laser elements 112 on the radiator plate 114. The heat sink 118 is a device for cooling the semiconductor laser elements 112. The semiconductor laser elements 112 emit linearly polarized blue color light with a wavelength width of 440 urn to 455 nm. The semiconductor laser elements 112 are arranged such that the polarization direction of light emitted from each laser element 112 is s-polarization with respect to the plane of incidence of a dichroic mirror 130.

The light emitted from the light source unit 110 enters a convex lens 122 and is condensed (reduced in diameter) by the convex lens 122, to be incident on a mirror 124. The mirror 124 changes the optical path to make the light from the convex lens 122 enter a concave lens 126. The mirror 124 is oriented with a predetermined angle (i.e., 55°) with respect to a principal ray of light outgoing from the lens 122. This causes the light to enter the dichromic mirror 130 at the predetermined angle (55°). The light of which optical path is changed enters a plano-concave lens 126 and is again converted to a parallel light. The light converted to parallel light enters the dichromic mirror 130 through a diffuser 128. The diffuser 128 has a function of reducing the coherence while keeping the polarization property.

The dichroic mirror 130 is oriented on the optical path to cause the light to enter and leave the dichroic surface at the predetermined incident angle (55°) The light reflected by the dichroic mirror 130 enters a λ/4 plate 132 to be converted into circularly polarized light. The circularly polarized light is condensed by the lens 134 to be irradiated on a fluorescent wheel 136 with a spot diameter of 1 to 2 mm. The fluorescent wheel 136 includes an aluminum flat plate and is divided into a region B as an area of a diffuse reflecting surface, a region G that is coated with a fluorescent substance emitting green color light, and a region R that is coated with fluorescent substance emitting red color light.

The light irradiated on the fluorescent wheel 136 is reflected intactly on the region B, whereas blue color light is converted into green color light and red color light in the region G and the region R, respectively, with the converted color light being emitted toward the lens 134. The color light is again converted into parallel light by the lens 134 to enter the λ/4 plate 132. By again passing through the λ4 plate 132, the blue color light is converted into p-polarized light to enter the dichroic mirror 130. The green and red color light converted by the fluorescent substance also enter the dichroic mirror 130. The dichroic mirror 130 has characteristics, for light with 440 nm to 445 nm in wavelength, of transmitting about 94% or more p-polarized light and reflecting s-polarized light at a high reflectance of 98% or more. Due to such characteristics, the blue color light incident on the dichroic mirror 130 via the diffuser 128 is reflected by the dichroic mirror 130, whereas the blue color light incident from the λ/4 plate 132 passes through the dichroic mirror 130. Thus, all the color lights incident from the λ/4 plate 132 pass through the dichroic mirror 130. As a result, the blue, green, and red color lights are emitted in a time-shared way.

The blue, green, or red color lights passing through the dichroic mirror 130 enters a pair of fly-eye lenses 138 and 140 composed of a plurality of lens elements. Light flux incident on the first fly-eye lens 138 is split into multiple light fluxes. The multiple light fluxes are converged on the second fly-eye lens 140. The lens elements of the first fly-eye lens 138 have an opening shape similar to the DMD 162 of the image generating unit 160. The lens elements of the second fly-eye lens 140 have a focal length defined to satisfy a condition that the first fly-eye lens 138 and the DMD 162 have a substantially conjugate relationship. The light outgoing the second fly-eye lens 44 enters a lens 142. The lens 142 is a lens for superimposing the light outgoing from the lens elements of second fly-eye lens 140 on the DMD 162. The light leaving the lens 142 is reflected by a mirror 144 and thereafter passes through a lens 164 to enter a total reflection prism 166.

The total reflection prism 166 includes two prisms 168 and 170 with a thin air layer 172 formed on adjoining surfaces of the two prisms. The air layer 172 totally reflects light incident at an angle not less than a critical angle. The light incident on the total reflection prism 166 via the lens 164 passes through a total reflection surface to enter the DMD 162. The DMD 162 deflects the micromirrors to cause the light to enter a projection lens 182 or advance toward the outside of the effective range of the projection lens 182, according to a video signal. The light reflected by the DMD 162 enters the air layer 172 at an angle not less than the critical angle and hence reflects to be incident on the projection lens 182. Thus, the image light formed by the DMD 162 is projected on a screen (not shown).

### 3. Internal Configuration of Second Housing

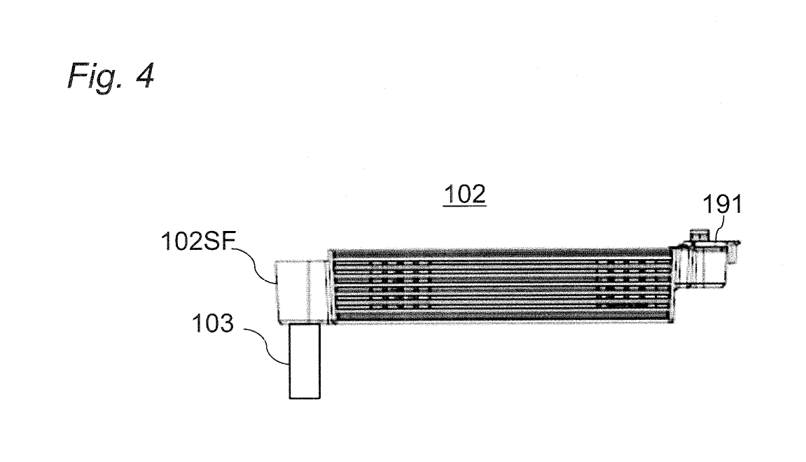

The internal configuration of the second housing 102 of the projection type image display device 100 of the present disclosure will be described with reference to FIG. 4. FIG. 4 is a side view of the second housing 102.

The first housing 101 mainly stores optical components. On the contrary, the second housing 102 mainly stores a power-supply unit (power-supply circuit) that supplies power from a wiring duct rail 90 to the light source unit 110, the illuminating unit 120, the image generating unit 160, and the controller 190. As shown in FIG. 4, the top surface of the second housing 102 is mounted with an attachment 191 for attaching the second housing 102 to the wiring duct rail 90. The projection type image display device 100 is supplied with power from the wiring duct rail 90 via the attachment 191. At a place where the wiring duct rail 90 is disposed on the ceiling or the like, the attachment 191 are fitted to the wiring duct rail 90 so that placement of the projection type image display device 100 and wiring of the power supply can easily be carried out. The joint unit 103 supporting the first housing 101 is fitted to the underside of the front 102SF of the second housing 102. As shown in FIG. 1, the second housing 102 is provided with an audio output terminal 194A for outputting an audio signal to an external device and a USB terminal 194U for connecting a USB device.

### 4. Configuration of Joint Unit

The configuration of the joint unit 103 connecting the first housing 101 and the second housing 102 will be described with reference to FIG. 1 and FIGS. 5A to 7. The joint unit 103 is configured using a ball joint mechanism.

In the following description, “vertical direction”, “horizontal direction”, “transverse direction” “up-and-down direction”, etc., will be described assuming the status where the second housing 102 is attached to the wiring duct rail 90 disposed on the ceiling and where the first housing 101 is hung for use vertically and downwardly by the joint unit 103.

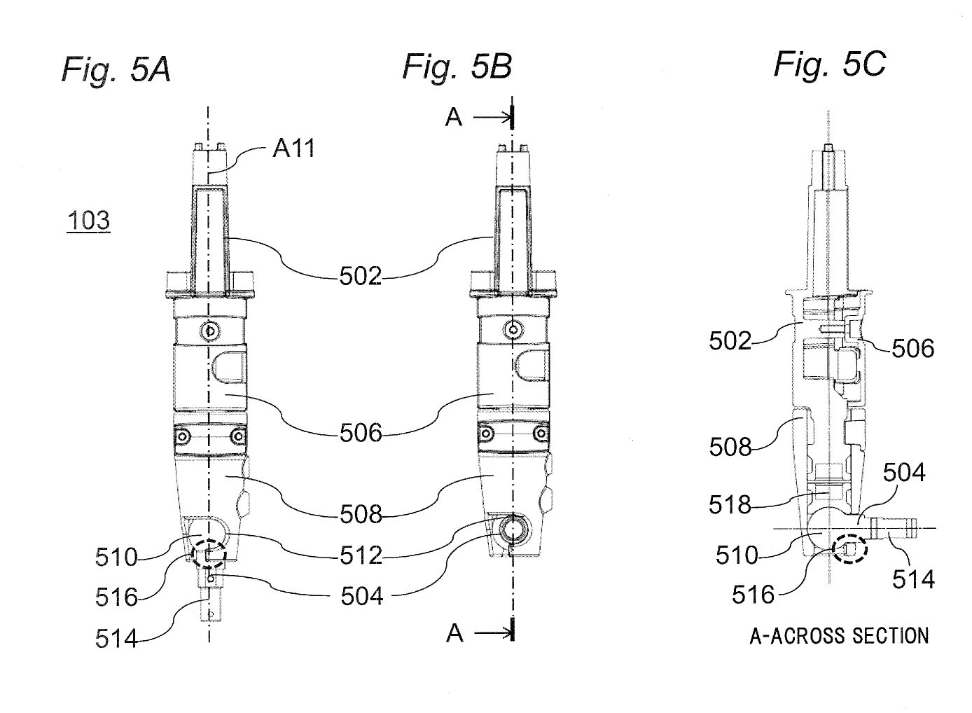

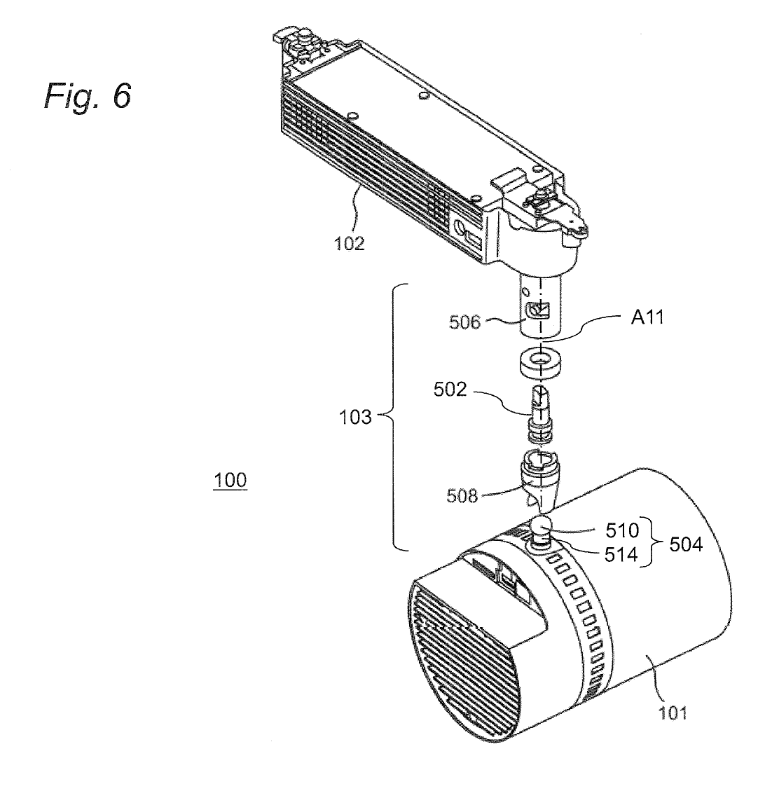

As shown in FIGS. 5A-5C and 6, the joint unit 103 includes a pole 502 (an example of a second holding portion) connecting the first housing 101 and the second housing 102, a ball shaft 504 (an example of a shaft member) having a ball portion 510, and a shaft holder 508 (an example of a first holding portion) embracing and holding the ball portion 510 (spherical portion). The upper portion of the pole 502 is covered with a pole cover 506 which is connected with a wire (not shown) restraining rotation around a vertically extending axis of the joint unit 103. The lower portion of the pole 502 is covered with the shaft holder 508 holding the pole 502 and the ball shaft 504. The ball shaft 504 has a shaft portion 514 connected to the spherical ball portion 510. The ball portion 51U is slidably received in a hollow portion of the shaft holder 508. The ball portion 510, the shaft portion 514, and the shaft holder 508 make up the ball joint mechanism.

In the joint unit 103, the shaft holder 508 is configured to be horizontally rotatable around a vertically extending axis A11 against the pole 502. In other words, the shaft holder 508 (i.e., ball shaft 504) is able to horizontally rotate (yawing) around the vertical axis A11.

Rotation of the ball shaft 504 against the shaft holder 508 (specifically, sliding of the ball portion 510 of the ball shaft 504 against the inner wall of the hollow portion of the shaft holder 508) enables the ball shaft 504 to rotate around the center of the ball portion 510 as a center of rotation. That is, the ball shaft 504 can freely rotate in various directions around the center of the ball portion 510, as the center of rotation until the ball shaft 504 abuts against an end of the shaft holder 508 to be immovable. In this manner, the ball joint mechanism enables the orientation of the first housing 101 to be freely set within a predetermined limited angular range.

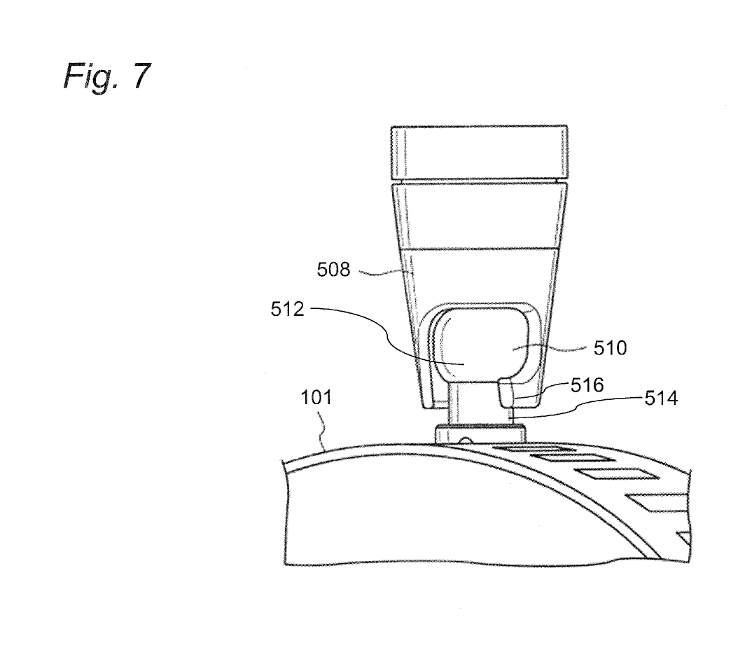

As shown in FIG. 7, the end of the shaft holder 508 is provided with a notched portion 512 which is formed by cutting away a semicircular portion of an outer wall defining the hollow portion according to the outer diameter of the shaft portion 514. The shaft portion 514 of the ball shaft 504 can take a state where the shaft portion 514 is fully received in the notched portion 512, a state where the shaft portion 514 is fully exposed from the notched portion, and an intermediate state therebetween. This notched portion 512 enlarges a movable range of the ball shaft 504 and especially enables rotation in the roll direction of the first housing 101. As used herein, the roll direction refers to a direction of rotation of the first housing 101 around an axis parallel to the optical axis.

Furthermore, a support portion (protruding portion) 516 is disposed at the end of the shaft holder 508 that is formed with the notched portion 512. As a result of disposing this support portion 516 in the notched portion 512, the notched portion 512 has an inverted L-like shape. This inverted L-like shape includes a region through which the shaft portion 514 passes when the shaft portion 514 is moved in the notched portion 512 and a region where the shaft portion 514 is enabled to move horizontally with the shaft portion 514 being fully received in the notched portion 512. In this manner, since the notched portion 512 has the inverted L-like shape, the shaft portion 514 can rotate horizontally in the notched portion 512 even after the shaft portion 514 is fully received within the notched portion 512. Thus, in the case where the first housing 101 is supported from above by the joint unit 103, the shaft portion 514 can be rotated in a roll direction to be fully received in the notched portion 512, and thereafter the shaft portion 514 can be shifted in a horizontal direction in the notched portion 512 to be located at the upper portion of the support portion 516. At this time, the shaft portion 514 is supported from below by the support portion 516 (see FIG. 5C). In this manner, when the shaft portion 514 is received in the notched portion 512, the shaft portion 514, that is, the first housing 101 can be supported against gravity by the support portion 516 so that the posture of the first housing 101 can be stably kept.

In the state where the shaft portion 514 is fully received in the notched portion 512, the notched portion 512 limits, by its shape, the range of horizontal rotation of the shaft portion 514 (i.e., first housing 101) to a predetermined range. Specifically, the range of horizontal rotation of the shaft portion 514 (i.e., first housing 101) is limited to the range of 0° to 90° with the shaft portion 514 being fully received in the notched portion 512. The range of 0° to 90° is mere exemplification and therefore the range of angle is not limited thereto. On the other hand, in the up-and-down direction, the shape of the notched portion 512 enables the shaft portion 514 (i.e., first housing 101) to rotate in a range of 90° from a position where the optical axis of an emitted image light extends horizontally to a position where it extends vertically downwardly (directly below).

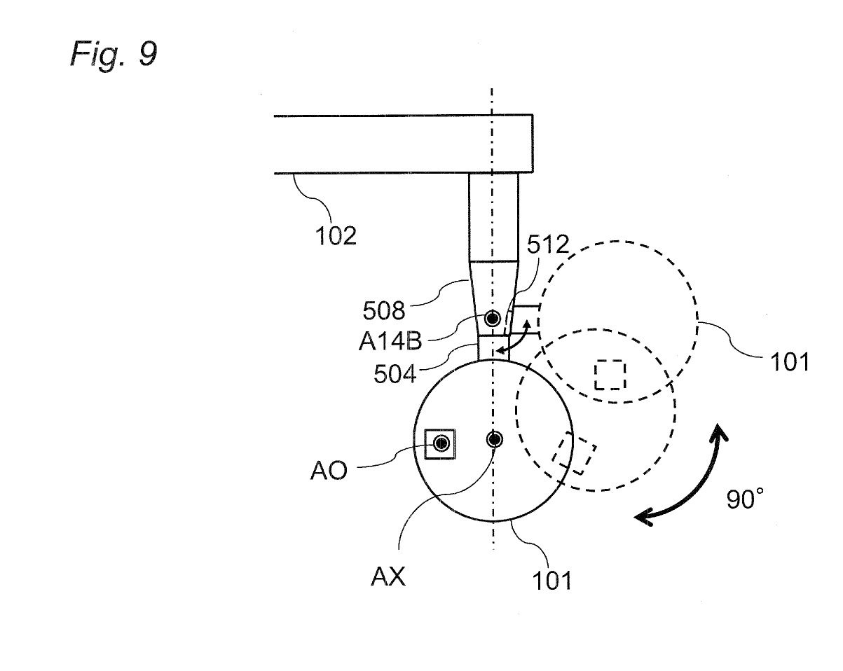

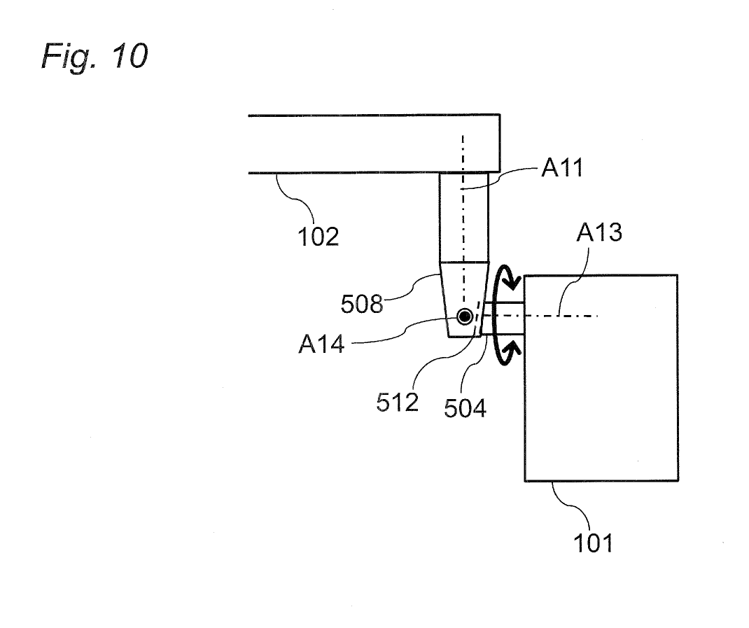

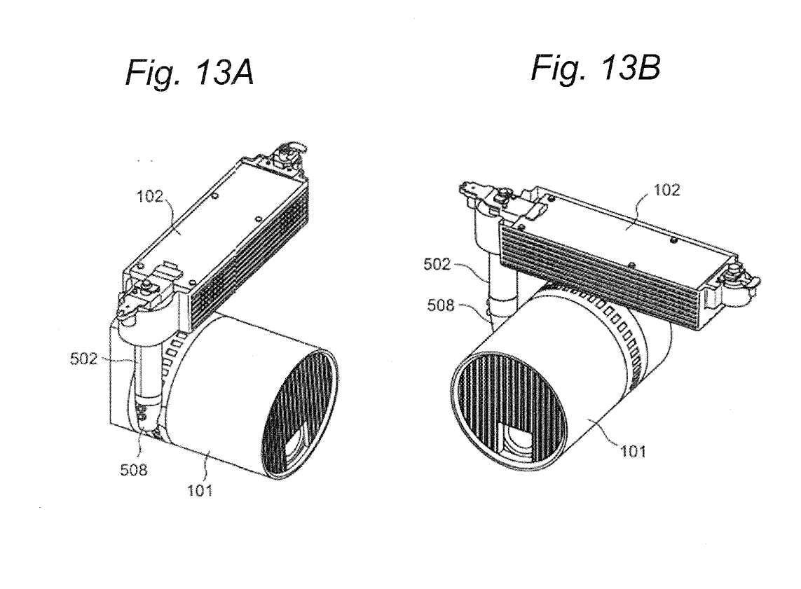

The rotatable direction of the first housing 101 with the shaft portion 514 received in the notched portion 512 differs depending on the positional (directional) relationship between the first housing 101 and (the notched portion 512 of) the shaft holder 508. For example, when the posture of the first housing 101 is kept horizontally in the state where the orientation of the back of the first housing 101 coincides with the orientation of the notched portion 512 disposed in the shaft holder 508, the first housing 101 is capable of the following rotation. That is, by rotating the first housing 101 to move the shaft portion 514 in the notched portion 512 to direct the front of the first housing 101 further downward, the orientation of the first housing 101 can be rotated in 90° from a horizontal direction to a vertically downward direction. This enables the orientation of the first housing 101 (i.e., the optical axis) to vary from a horizontal direction to downward direction (see FIGS. 10, 11A-11B and 12A-12B). When the posture of the first housing 101 is kept horizontally in the state where the orientation of the back of the first housing 101 is orthogonal to the orientation of the notched portion 512 formed on the shaft holder 508, the first housing 101 is capable of the following rotation. That is, by moving the first housing 101 around a horizontal axis extending through the center of the ball portion 510 and parallel to the optical axis so that the whole of the first housing 101 while keeping the posture of the first housing 101 horizontally), the first housing 101 is enabled to rotate 90° in the roll direction (see FIGS. 9 and 13A-13B that will be described later).

As shown in FIG. 5C, a lock portion 518 is interposed between the pole 502 and the ball shaft 504. The lock portion 518 includes a coil spring (not shown) so that when the ball shaft 504 rotates around the horizontal axis, a spring force of the coil spring urges downward the ball portion 510 toward the shaft holder 508, thereby enabling the position to be fixed without using a screw, etc.

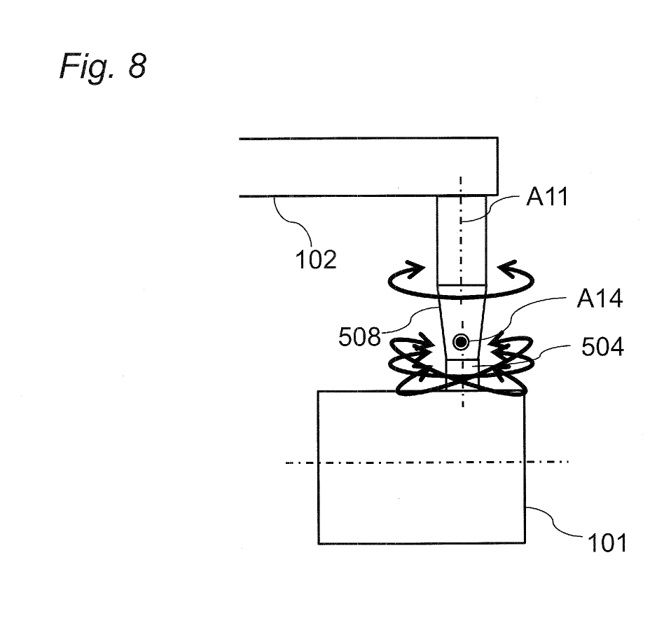

FIGS. 8 and 9 are views for explaining rotation of the first housing 101 against the second housing 102. For example, as shown in FIG. 8, united rotation of the ball shaft 504 and the shaft holder 508 against the pole 502 allows the first housing 101 to rotate in the horizontal direction (Yaw direction) around the vertically extending axis A11. Horizontal rotation of the ball shaft 504 against the shaft holder 508 also enables the first housing 101 to rotate in the horizontal direction. In the ball joint mechanism, rotation of the ball shaft 504 against the shaft holder 508 allows the ball shaft 504 to freely rotate in various directions (horizontal direction, up-and-down direction within the limited range, roll direction within the limited range) around the center of the ball portion 510 as the center of rotation until the ball shaft 504 abuts against an edge of the shaft holder 508 to become immovable.

FIG. 9 is a view explaining the state at the time of rotation the first housing 101 in a range of 90° in the roll direction. By moving the shaft portion 514 to the notched portion 512, the first housing 101 can take any state between a state where the shaft portion 514 lies beneath the joint unit 103 and a state where the shaft portion 514 is fully received in the notched portion 512 to be kept horizontally. That is, the first housing 101 can be rotated in the roll direction around an axis A14B as a rotational axis extending through center of the ball portion 510.

In this embodiment, as shown in FIG. 9, an optical axis (AO) of the projecting unit 180 is set at a position not intersecting the center of the pole 502, i.e., a position offset from a center axis (AX) of the first housing 101.

By further rotating the ball shaft 504 around a horizontal axis A13 (center of the ball portion 510) against the shaft holder 508 in the state where the first housing 101 is rotated 90° in the roll direction (the state indicated by a broken line of FIG. 9 where a portrait-orientation projection is possible), the first housing 101 can be rotated in the up-and-down direction (pitch direction) in the state where the vertical position projection is possible, as shown in FIG. 10. When the shaft portion 514, i.e., the ball shaft 504 is supported by the support portion 516 as shown in FIG. 10, the direction of the axis A13 around which the shaft portion 514 is rotatable differs from the direction of the rotational axis A11.

As described above, according to the joint unit 103 of this embodiment, the ball shaft 504 can rotate around the axis of the ball shaft 504 as a rotational axis against the shaft holder 508 in the state where the shaft portion 514 is received in the notched portion 512 (including the state where the shaft portion 514 is supported by the support portion 516). That is, the ball shaft 504 is freely rotatable in the up-and-down direction. On the other hand, in the horizontal direction, the ball shaft 504 can, first of all, rotate within the region of the notched portion 512. In the case where the ball shaft 504 is further rotated toward the end surface of the notched portion 512 (shaft holder 508) with the ball shaft 504 abutting against the end surface, the ball shaft 504 can rotate around the axis A11 along with the shaft holder 508. That is, since the shaft holder 508 can rotate around the axis A11 against the pole 502, the shaft portion 514 can rotate horizontally around the axis A11 even in the state where the shaft portion 514 is received in the notched portion 512. Accordingly, in the state where the shaft portion 514 is received in the notched portion 512, the first housing 101 can rotate through any angle in each of the horizontal direction and the up-and-down direction, enabling the direction of the first housing 101, that is, direction of the optical axis to be freely set. The force pressing the ball portion 510 of the lock portion 518 may be properly adjusted, so that the ball shaft 504 and the shaft holder 508 can be integrally rotated horizontally even in the state where the ball shaft 504 does not abut against the end surface of the notched portion 512 (shaft holder 508).

On the other hand, in the state where the shaft portion 514 is not received in the notched portion 512, the ball joint mechanism enables rotation in various directions (horizontal direction, vertical direction within the limited range, roll direction within the limited range) within the limited range around the center of the ball portion 510 as the rotational center. At that time, since the shaft holder 508 can be rotated around the axis A11 against the pole 502, the shaft portion 514 also can horizontally rotate (Yaw) around the axis A11 along with the shaft holder 508 (see FIG. 8).

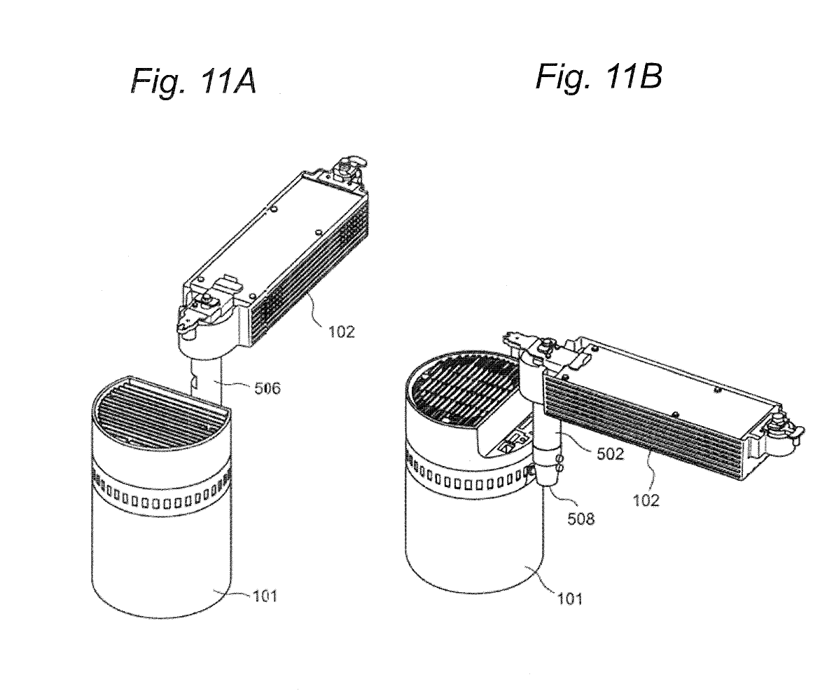

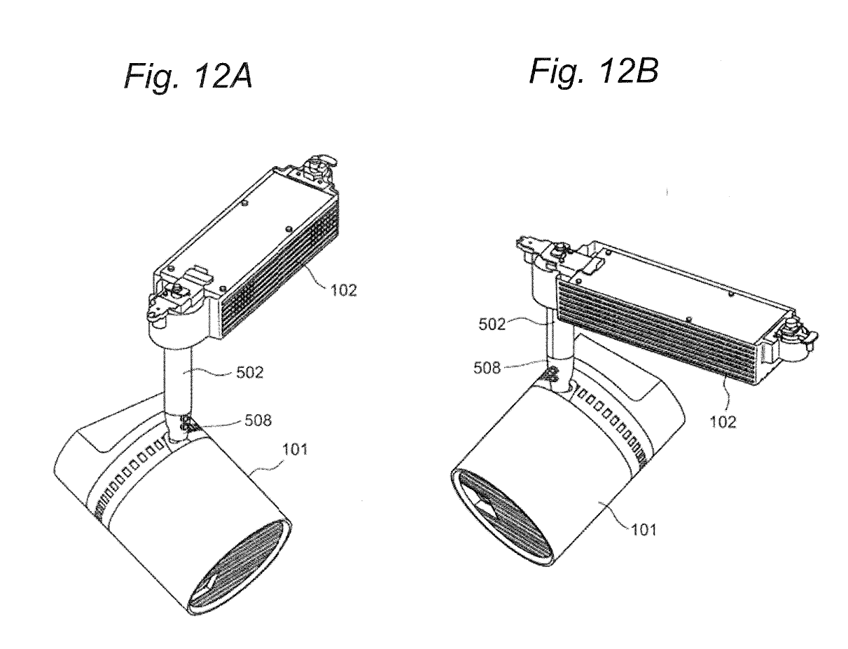

FIGS. 11A to 13B are views explaining examples of specific postures that the first housing 101 can take against the second housing 102. FIGS. 11A-11B show a posture of the first housing 101 which is kept vertically downwardly. FIGS. 12A-12B show a posture of the first housing 101 which is kept diagonally downward. FIGS. 13A-13B show a posture of the shaft portion 514 which is kept in the horizontal state by the support portion 516 with the first housing 101 being rotated 90° in the roll direction.

In this manner, the joint unit 103 enables the first housing 101 to be set to various postures, by the vertically extending rotational axis A11 against the pole 502 of the shaft holder 508 and the ball joint mechanism including the shaft holder 508 and the ball portion 510. Thus, the projection type image display device 100 of the present embodiment can freely project image light into a space below the device, by combining the rotational axis A14B in the roll direction extended by the notched portion 512 and the vertically extending axis A11 capable of rotating through 360°, in addition to the rotational axis A14 with a rotational center which is the center of the ball portion 510.

### 5. Effect, etc.

The projection type image display device 100 of the present disclosure includes the light source unit 110, the image generating unit 160 configured to modulate light from the light source unit 110 according to a video input signal to generate image light, the projecting unit 180 configured to project the generated image light, the first housing 101 that houses the light source unit, the image generating unit, and the projecting unit, the second housing 102, and the joint unit 103 configured to connect the first housing 101 and the second housing 102 and support the first housing 101 to be able to rotate within a predetermined angular range. The joint unit 103 includes a ball joint mechanism having the ball shaft 504 (one example of a shaft member) with the ball portion 510 (a spherical portion), the shaft holder 508 (one example of a first holding portion) embracing and holding the ball portion 510, and the pole 502 (one example of a second holding portion). The ball portion 510 of the ball shaft 504 is held rotatably by the shaft holder 508. The shaft holder 508 is configured to be rotatable around a predetermined rotational axis A11 against the pole 502.

The projection type image display device 100 of the present embodiment has the 360° rotatable vertically extending axis A11 in addition to the rotational axes A14 and A14B arising from the ball joint mechanism. Thus the projection type image display device 100 can freely set the posture of the first housing and arbitrarily adjust the angle of emission of the projection light.

### Second Embodiment

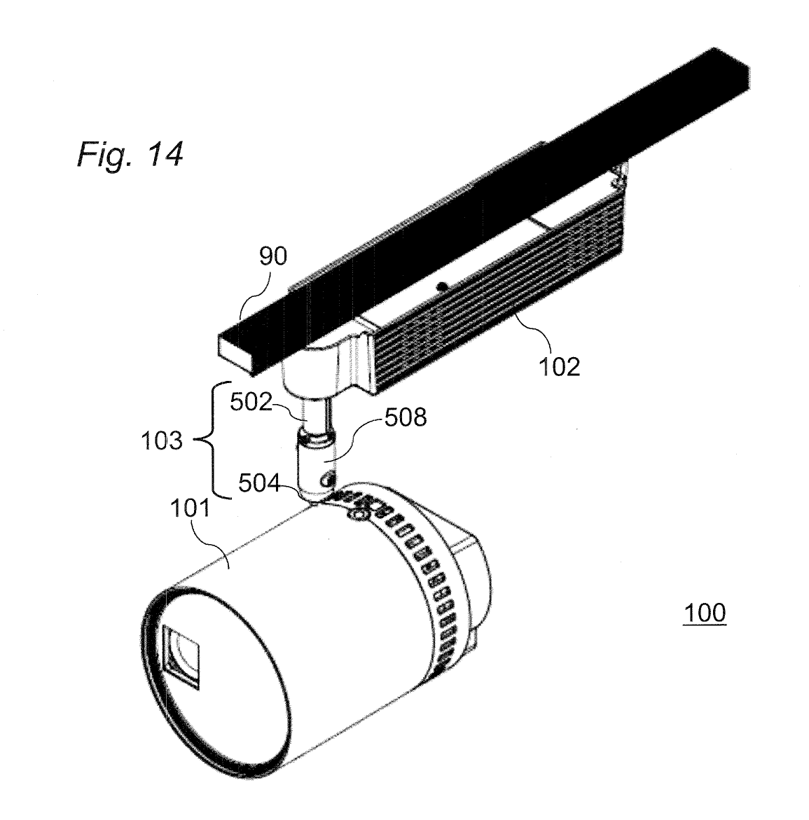

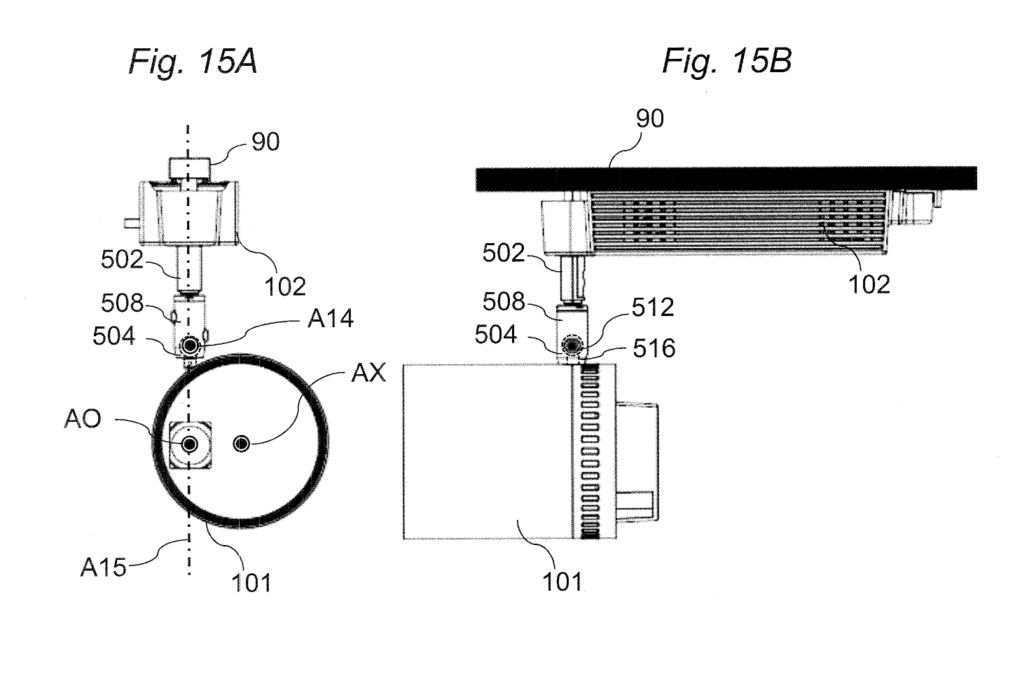

Still another configuration of the joint unit connecting the first housing and the second housing according to the present disclosure will be described with reference to FIGS. 14 and 15A-15B. It is to be noted that in the following description, points differing from the first embodiment will be mainly described.

In the present embodiment as well, similar to the first embodiment, the joint unit 103 is configured from the components such as the pole 502, the ball shaft 504, and the shaft holder 508. Although not shown in FIGS. 14 and 15A-15B, the ball shaft 504 has the ball portion 510 and the shaft portion 514, similar to the first embodiment. The shaft holder 508 has the notched portion 512 and the support portion 516.

In the present embodiment, the pole 502 is disposed on the same plane as the optical axis (AO) of the projecting portion 180. In the first embodiment, the center of the pole 502 intersects the center axis (AX) of the first housing 101 as shown in FIG. 9. However, in the present embodiment, a pole 502 is fitted to the first housing 101 such that the axis of the pole 502 does not intersect the center axis (AX) of the first housing 101. Hence, when horizontally rotating around the vertically extending axis (A15) is 0°, the optical axis (AO) of the projecting unit 180 coincides with the center of rotating around the vertically extending axis (A15) and with the center of up-and-down rotation around the horizontally extending axis (A14), thus improving the convenience of placement of the image display device 100.

### Third Embodiment

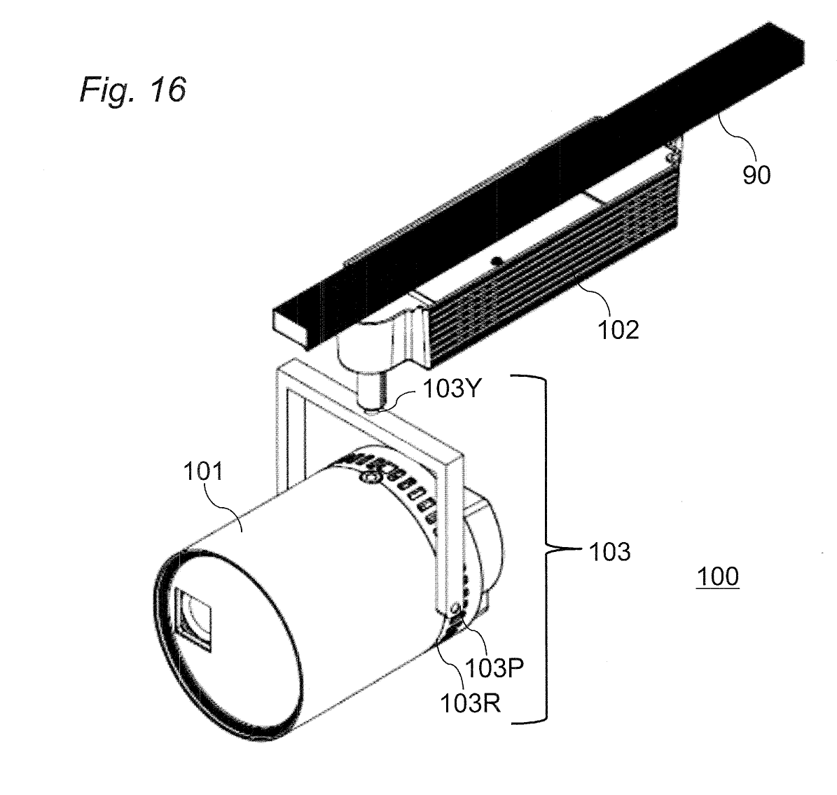

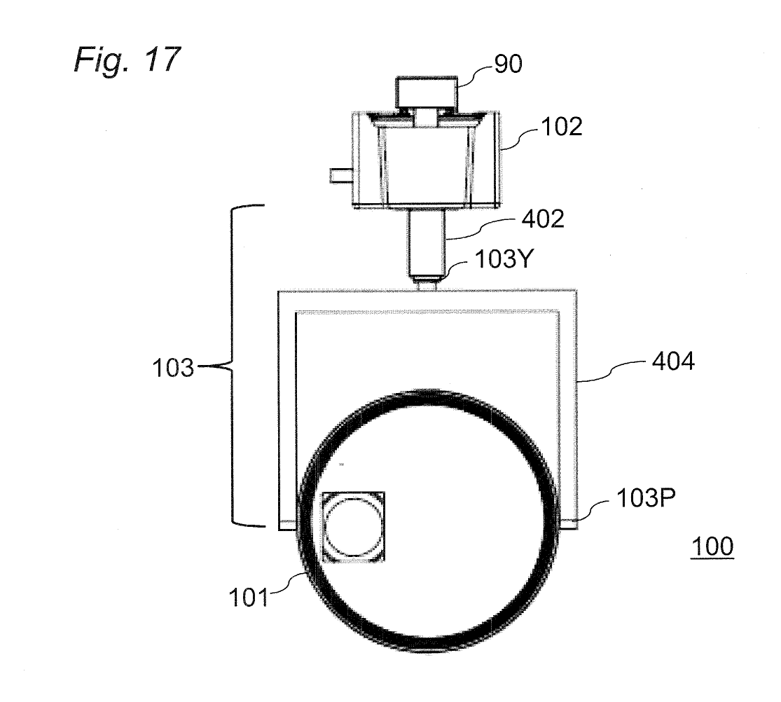

Still yet another configuration of the joint unit 103 connecting the first housing 101 and the second housing 102 according to the present disclosure will be described with reference to FIGS. 16 and 17. Hereinafter, points different from the first embodiment will be mainly described. FIGS. 16 and 17 are a perspective view and a front view of the projection type image display device of the third embodiment, respectively.

As shown in FIGS. 16 and 17, the first housing 101 and the second housing 102 are connected together by the joint unit 103 which can rotate around mutually independent three axes. The joint unit 103 includes first to third joints 103Y, 103P, and 103R. The first joint 103Y enables horizontal rotation (yawing) of the first housing 101 around the vertically extending axis. The second joint 103P enables pitching of the first housing 101 in up-and-down direction of the first housing 101 around the horizontally extending axis. The third joint 103R enables rolling of the first housing 101 along the peripheral direction of the first housing 101 around a center line (center axis) of the cylinder of the first housing 101 having a substantially cylindrical shape.

Description will be given of the configuration of the joint unit 103 connecting the first housing 101 and the second housing 102 of the projection type image display device 100 according to the present disclosure.

As described above, the joint unit 103 has the first joint 103Y enabling yawing of the first housing 101 around the vertically extending axis, the second joint 103P enabling pitching of the first housing 101 in up-and-down direction around the horizontally extending axis, and the third joint 103R enabling rolling of the first housing 101 along the peripheral direction of the first housing 101 around a center axis (as the rotational axis) of the substantially cylindrical shape (or an axis parallel to the optical axis). That is, the projection type image display device 100 is configured to be rotatable around three orthogonal axes.

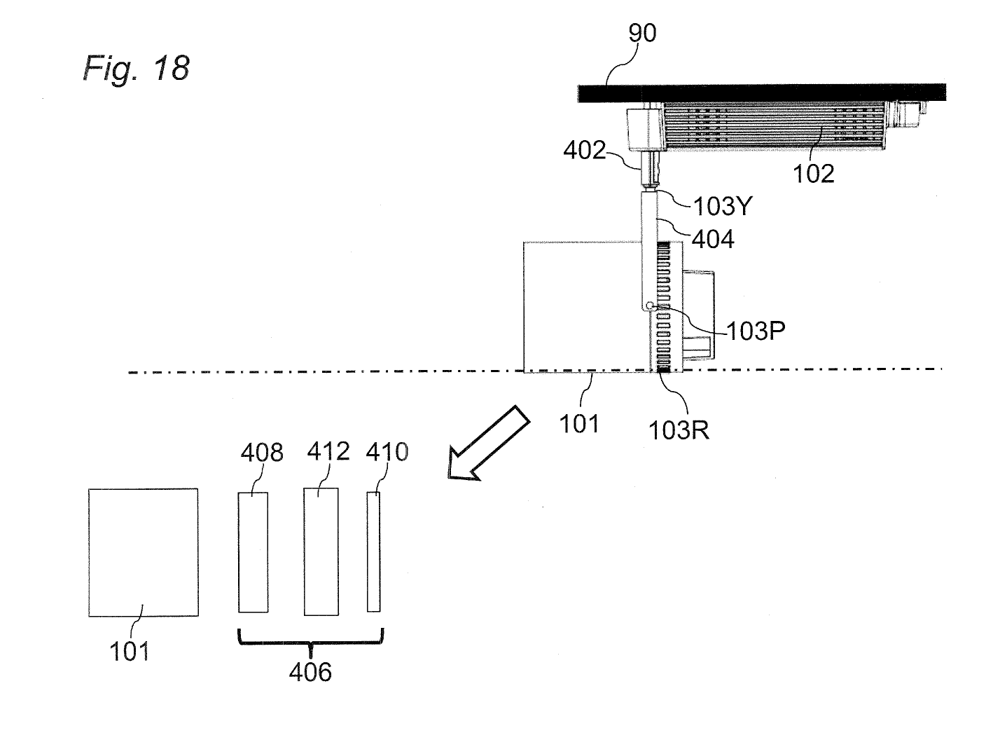

Specifically, as shown in FIG. 18, an aluminum hinge 402 and a hinge arm 404 are connected together to be rotatable around the vertically extending axis. This connecting portion composes the first joint 103Y. The hinge arm 404 is connected to a hinge holder 406 composing a part of the side surface of the first housing 101. This connecting portion composes the second joint 103P enabling pitching of the first housing 101 in up-and-down direction.

The hinge holder 406 has a first hinge holder 408 and a second hinge holder 410 for fixing internal components of the housing 101 and a third hinge holder 412 having a guide (not shown) formed in its inner wall. By rotation the first hinge holder 408 and the second hinge holder 410 along the guide of the third hinge holder 412, the optical components, and so on are rotated along the peripheral direction of the first housing 101. Such a hinge holder 406 composes the third joint 103R. The guide is disposed in the range of not less than 0° and not more than 90° and the optical components, and so on are configured so as to be rotatable in the range of 0° to 90°. On the other hand, the outer wall of the third hinge holder 412 is provided with graduations (not shown) which can be used as a yardstick when the user sets the first housing 101 to a desired angle.

The rotational axis of the third joint 103R is parallel to the optical axis of the projecting unit 180 (projection lens 182). Thus, rotating the third joint 103R by 90° enables the projection type image display device 100 to provide a portrait (vertically long) display. Due to configuration to be rotatable through 0° to 90° on one side, it is also easy to set the portrait display and to return the state to the ordinary state. Furthermore, an angle sensor such as gyro sensor may be mounted in the first housing 101. With this arrangement, it is also possible to detect the posture of the first housing 101 and to automatically switch the display between the portrait display and the ordinary display based on the detected posture.

When the projection type image display device 100 is turned on after power off of the projection type image display device 100 which is in the state of portrait display, it is preferable to activate the projection type image display device 100 in the state of portrait display. Similarly, in cases where the projection type image display device 100 is turned off while being used as an illumination device (illumination mode), the device 100 may be activated in the illumination mode when it is turned on next. Further, in cases where the image display device 100 is turned off in the state where an image is projected (projection mode), the device may be activated in the projection mode when it is turned on next.

### Other Embodiments

As described above, the first to third embodiments have been described as exemplifications of the technique disclosed in the present application. The technique of the present disclosure, however, is not limited thereto but is applicable to embodiments properly undergoing changes, permutations, additions, omissions, etc. It would also be possible to provide new embodiments by combining the constituent features set forth in the above first to third embodiments. Thus, other embodiments will be exemplified hereinbelow.

(A) Although in the above embodiments the example has been described in which the shape of the first housing 101 of the projection type image display device is cylindrical, the shape of the first housing 101 is not limited thereto. The shape of the first housing 101 may be quadrilateral, elliptical, or oval in section. Chamfering or corner roundness may properly be applied to the shape. Further, not only the cylindrical shape but also barrel shape may also be employed, in view of the affinity (a sense of beauty) with the space in which the image display device 100 is located.

(B) In the above embodiments the configuration has been described in which the display mode is changeable between the ordinary (horizontally long) display mode and the portrait display mode due to rotation of the hinge holder through the range of 0° to 90°. However the display mode is not limited to these two modes, that is, the ordinary mode and the portrait mode. Oblique angle display may be employed. In this case, if the third hinge holder is provided with graduations, the oblique angle adjustment becomes easy.

(C) Although in the above embodiments the projection type image display device has been used as an example of electronic equipment to which the idea of the present disclosure is applicable, the idea of the present disclosure could be applied to other electronic equipment as well. That is, the idea of the above joint unit is applicable to any electronic equipment including a first object (component, member, housing, chassis, case, etc.), a second object (component, member, housing, chassis, case, etc.), and a joint unit connecting those objects, the joint unit supporting rotatably the first object and the second object.

As described above, the embodiments have been described as exemplifications of the technique in the present disclosure. To this end, the accompanying drawings and the detailed description have been provided.

Therefore, among the constituent elements described in the accompanying drawings and the detailed description, there may be included not only essential constituent elements to solve the problem but also constituent elements not essential to solve the problem. For this reason, immediately from the fact that their unessential constituent elements are described in the accompanying drawings and the detailed description, it should not be identified that their unessential constituent elements are essential.

Since the above embodiments are for the exemplifications of the technique in the present disclosure, various changes, permutations, additions, omissions, etc., may be made in the scope of the patent claims or in its equivalent scope.

### INDUSTRIAL APPLICABILITY

The present disclosure is applicable to a projection type image display device such as a projector.

1. A projection type image display device comprising:
a light source unit;
an image generating unit configured to modulate light from the light source unit according to a video input signal to generate image light;
a projecting unit configured to project the generated image light;
a first housing that houses the light source unit, the image generating unit, and the projecting unit;
a second housing; and
a joint unit configured to connect the first housing and the second housing, and support the first housing to be able to rotate within a predetermined angular range,
wherein the joint unit includes a ball joint mechanism having a shaft member with a spherical portion, a first holding portion embracing and holding the spherical portion, and a second holding portion,
the spherical portion of the shaft member is held rotatably by the first holding portion, and
the first holding portion is configured to be rotatable around a predetermined rotational axis against the second holding portion.

2. The projection type image display device according to claim 1, wherein
the first holding portion has at its end portion a hollow portion embracing the spherical portion, and a notched portion is formed on a part of an outer wall defining the hollow portion.

3. The projection type image display device according to claim 2, wherein
in the first holding portion, a support portion is provided at the end portion in which the notched portion is formed, and
the support portion is a member for supporting the shaft member from below when the shaft member is placed on top of the support portion in a state where the first housing is hung and supported by the joint portion.

4. The projection type image display device according to claim 3, wherein
a direction of the predetermined rotational axis is different from a direction of an axis around which the shaft member can rotate while the shaft member is supported by the support portion.

5. The projection type image display device according to claim 1, wherein
the predetermined rotational axis is an axis extending in a vertical direction of a case where the first housing is hung and supported by the joint portion.

6. The projection type image display device according to claim 1, wherein
the direction of rotation of the predetermined rotational axis is a direction orthogonal to the axial direction of rotational axis.

7. The projection type image display device according to claim 1, wherein
the joint unit further has a lock portion pressing the spherical portion inside the first holding portion.

8. The projection type image display device according to claim 1, wherein
the second housing houses a power supply unit for supplying electric power to the light source unit and the image generating unit.
